(19) United States
(12) Patent Application Publication
(10) Pub. No.: US 2009/0254413 A1
(43) Pub. Date: Oct. 8, 2009

(54) Portfolio Modeling and Campaign Optimization

(75) Inventors: Lulinyu Laura Chang, Bayside Hills, NY (US); Shen Y. Chang, Rockaway, NJ (US); Kathleen B. Haggerty, Staten Island, NY (US); Anuja Malik, Janak Puri (IN); Justin Andrew Maynard, New York, NY (US); Venkat Varadachary, New York, NY (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Co., Inc., a New York Corporation

(21) Appl. No.: 12/098,897

(22) Filed: Apr. 7, 2008

(51) Int. Cl. G06F 17/30; G06Q 30/00; G06Q 90/00

(52) U.S. Cl. 705/10; 705/14

(57) ABSTRACT

In an embodiment of the invention, historical data related to multiple members of a customer loyalty program is gathered. A set of loyalty behavior models is developed for an individual member of the loyalty program is developed based on the historical data. For each campaign in a plurality of marketing campaigns, at least one combination of offers is inserted into each loyalty behavior model to output a plurality of net profit scores for the individual member, wherein each combination of offers outputs a separate net profit score. For each campaign in the plurality of campaigns, a combination of offers having the highest net profit score for the campaign is selected. The campaign having the highest net profit score of the plurality of campaigns is selected, and marketing materials for the selected campaign and combination of offers is transmitted to the individual member.

### BACKGROUND OF THE INVENTION

1. Field of the Invention

The inventions relate in general to customer loyalty programs associated with or operated by financial companies. More specifically, the inventions relate to predicting behavior of members of a loyalty program and applying predictions to campaigns and offers directed to loyalty program members in order to maximize benefits to the financial company.

2. Background Art

Customer loyalty programs, also known as “rewards programs,” have become a widely used tool of financial companies to encourage loyalty and other behaviors typically having some financial impact. Although such programs have become a strategic lever, the use of such programs is expensive. It is becoming increasingly important that marketing and other campaigns directed to loyalty program members be as effective as possible. Loyalty program members are not all the same. They come from different backgrounds, earn their money in different ways, have different expense profiles, etc. Thus, they do not all respond in the same way to specific types of campaigns. What is needed is a way to target the right offers to the right customers at the right times to obtain the best economic leverage of the rewards program membership.

### BRIEF SUMMARY OF THE INVENTION

An embodiment of the invention relates to a method and system for managing a customer loyalty program for an individual member of the customer loyalty program. In an embodiment, historical data related to multiple members of a customer loyalty program is gathered. A set of loyalty behavior models may be developed for an individual member of the loyalty program based on the historical data. For each campaign in a plurality of marketing campaigns, at least one combination of offers may be inserted into each loyalty behavior model to output a plurality of net profit scores for the individual member, wherein each combination of offers outputs a separate net profit score. For each campaign in the plurality of campaigns, a combination of offers having the highest net profit score for the campaign may be selected, wherein the net profit score for the selected combination of offers becomes the campaign's net profit score. The campaign having the highest net profit score of the plurality of campaigns may be selected, and marketing materials for the selected campaign and combination of offers may be transmitted to the individual member.

Another embodiment of the invention relates to a method and system for targeting a customer loyalty program member for a marketing campaign. In an embodiment, historical data related to multiple customer loyalty program members is gathered. A set of loyalty behavior models for a given campaign may be developed based on the historical data. A set of baseline behavior models based on the historical data may also be developed. For each individual of a plurality of individuals, at least one attribute of the individual may be inserted into each loyalty behavior model for the given campaign, wherein a separate campaign net profit score is output for each individual. For each individual in the plurality of individuals, at least one attribute of the individual may be inserted into the baseline behavior model, wherein a separate baseline net profit score is output for each individual. The campaign net profit score for each individual may be compared to the baseline net profit score for the individual. From the plurality of individuals, at least one individual having a campaign net profit score that is higher than the baseline net profit score for the individual may be selected. Marketing materials for the given campaign may then be transmitted to the selected at least one individual.

Another embodiment of the invention relates to a method and system for targeting a customer loyalty program member for a new type of marketing campaign. In an embodiment, historical data related to multiple customer loyalty program members is gathered. A set of baseline behavior models based on the historical data may also be developed. For each individual of a plurality of individuals, at least one attribute of the individual may be inserted into the set of baseline behavior models, wherein a separate baseline net profit score is output for each individual. Each individual may then be ranked based on the baseline net profit score output for the individual. From the plurality of individuals, at least one individual may be selected based on the ranked baseline net profit scores. Marketing materials for the new type of campaign may then be transmitted to the selected at least one individual.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a schematic diagram indicating various exemplary kinds of behavior models that can be constructed from customer historical data and other financial inputs.

FIG. 2 is a block diagram of an exemplary computer system useful for implementing the present invention.

FIG. 3 is a flowchart indicating a process for building a behavior model, according to an embodiment of the present invention.

FIG. 4a is a graphical representation of performance periods used to define and validate a model according to an embodiment of the present invention.

FIG. 4b is a representation of model performance periods according to another embodiment of the present invention.

FIG. 5 is a process flow diagram illustrating campaign and offer selection for an individual consumer according to an embodiment of the present invention.

FIG. 6 is a process flow diagram illustrating customer selection for a given campaign, according to an embodiment of the present invention.

FIG. 7 is a flowchart of an example embodiment in which baseline models are built and utilized in order to determine what kinds of marketing campaigns to launch.

FIG. 8 is a flowchart of an example embodiment in which campaign specific models are used in order to increase the effectiveness of future campaigns.

The present invention will be described with reference to the accompanying drawings. The drawing in which an element first appears is typically indicated by the leftmost digit(s) in the corresponding reference number.

### DETAILED DESCRIPTION OF THE INVENTION

### I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “end user,” “consumer,” “customer,” “participant,” “member,” and/or the plural form of these terms are used interchangeably throughout herein to refer to those persons or entities capable of accessing, using, being affected by and/or benefiting from the tool that the present invention provides for portfolio modeling and campaign selection.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

### 1. Transaction Accounts and Instrument

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

### 2. Use of Transaction Accounts

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like. The transaction accounts may be associated with loyalty programs to encourage use of the transaction accounts by a transaction account holder.

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

### II. Behavior Modeling

Customer behavior models are built in order to understand customer life cycle behavior on an individual customer level. Once the behavior models are built, they may be used to predict customer behavior for individual customers over a given period of time. Regarding consumer loyalty, behavior models can optimize marketing investment returns by determining whether a given marketing campaign will enhance loyalty engagement for the individual customer with a transaction account company, such as American Express Co. of New York, N.Y. The models can also be used to determine the best type of campaign to be used for the individual customer, as well as to determine the most profitable combination of offers within the campaign for the individual. Such offers may include, for example and without limitation, a campaign offer, a type of messaging, a channel, a duration of offer, and timing of the campaign.

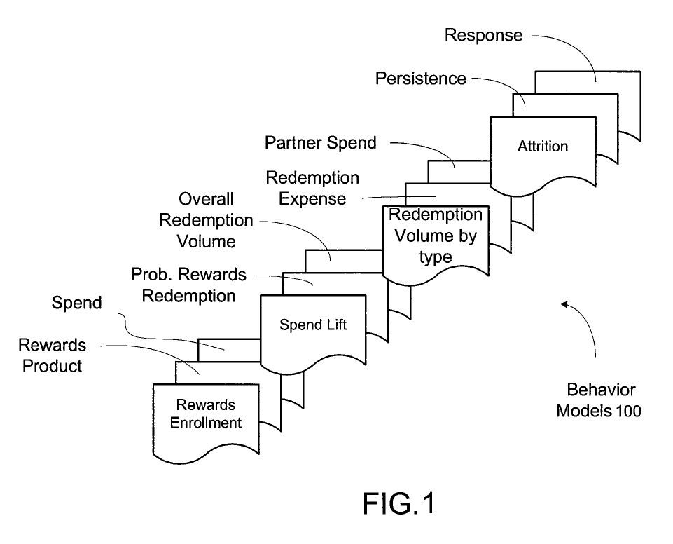

A behavior model is a collection of one or more consumer attributes and correlated effects the attributes have on consumer behavior. Although the present description will be made with reference to modeling behavior regarding a loyalty or rewards program associated with a transaction card provider, one of skill in the art will recognize that consumer behavior can be modeled for various uses without departing from the spirit and scope of the present invention. FIG. 1 is a schematic diagram indicating various kinds of behavior models 100 that can be constructed from customer historical data and other financial inputs. The following list is a representative sample of the kinds of models that can be built at the customer level: an attrition model, a rewards enrollment model, a rewards product model, a spend model, a spend lift model, a redemption model, an expense model, a response model, a persistence model, an overall spend model, an industry spend model, and a partner spend model. Attributes may include, for example and without limitation, spend capacity, location, program enrollment status, reward related data, customer profile, historical transactions, program value proposition, customer size of wallet, customer share of wallet, and the like. An example method to determine customer size of wallet and customer share of wallet may be found in U.S. patent application Ser. No. 11/694,086, filed Mar. 30, 2007, which is incorporated by reference herein in its entirety. Campaign-specific attributes may include, for example and without limitation, a campaign response indicator (e.g., whether the consumer responded to the campaign), campaign offers, spend threshold, etc. Each model may include attributes indicative of a particular effect. For example, an attrition model may include attributes that identify whether a customer is planning on leaving a program. The attributes in a model may be weighted depending on the level of their effect.

One of the specific types of models listed among the examples above is a redemption model. Such a model may suggest, for example, that a particular customer is likely to redeem points from a loyalty rewards program during a next six month period. Certain redemptions are more expensive (e.g., airline tickets) than others (e.g., retail merchandise). Thus, based on model redemption predictions, it may be advantageous to target such customers near the beginning of that six month period with a cross-redemption campaign encouraging the members to use their reward points to purchase less expensive rewards, such as retail merchandise.

Another of the specific types of models listed among the examples above is an attrition model. An attrition model may suggest that during a next six month period there is likely to be significant attrition of members (members leaving the rewards program). Such a model may be useful in strategy and planning to target loyalty program members likely to leave the loyalty program with a retention campaign. Such a campaign may provide an offer to a member likely to leave that would encourage such a member to stay by requiring the member to stay in the program to obtain some benefit. An attrition model may also do the reverse and predict how many new members are likely to join the loyalty program if offered membership.

Another of the specific types of models listed among the examples above is an overall spend model. Such a model may suggest a total amount of money that a customer is likely to spend that is subject to the loyalty program during a particular future time period without regard to how that amount will be apportioned to various types of services, industries, partners, etc.

Another of the specific types of models listed among the examples above is a spend persistency model. Such a model may predict how long a particular level of spending is likely to continue.

A partner spend model may suggest an amount of money a member will spend with a particular reward program partner. For example, the reward program may partner with a retail store, and target the member with offers to increase spend at the retail store.

An industry spend model relates to the amount to be spent in a particular type of endeavor, such as, for example, air, travel, lodging, and retail. For example, a model might predict that a customer may spend $3,000 in retail stores (not a particular partner store) during the next twelve months or spend $5000 in restaurants during the next six months, or $2000 in hotels during the next twelve months. The models can also predict the amount of spend in each such category.

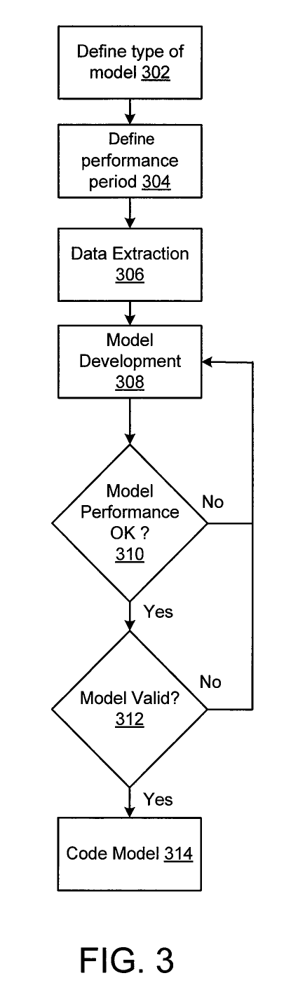

FIG. 3 is a flowchart indicating an exemplary process for building a model. Models may be built, for example, using data from previous and/or existing marketing campaigns. The overall process shown in the figure can be applied to building various kinds of models. At step 302, a type of model to build is determined.

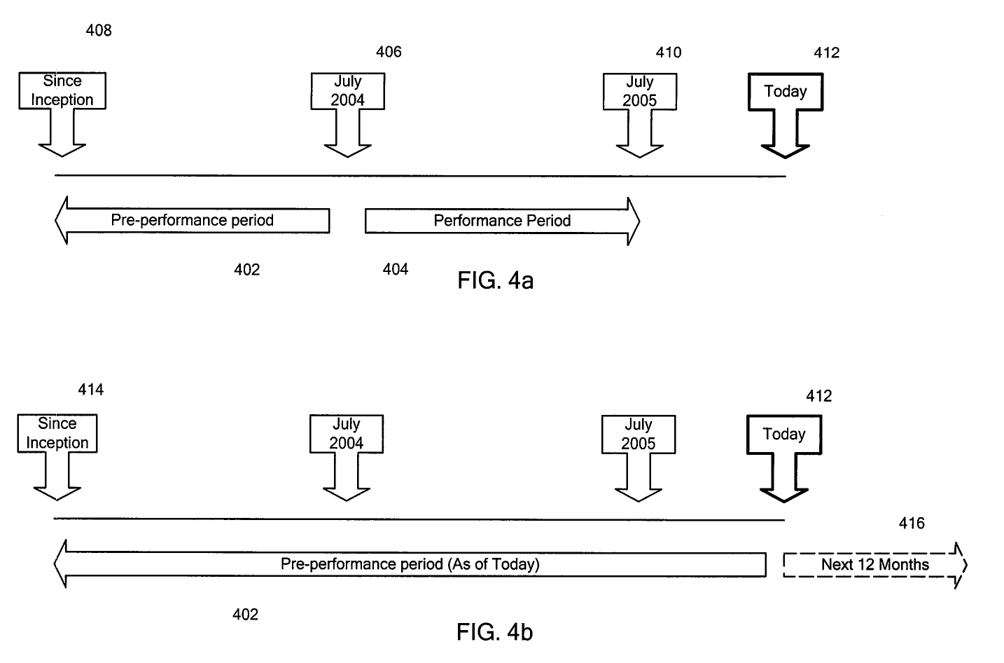

For the model type selected, performance time periods are selected at step 304. In some cases, there are defined “pre-performance” and “performance” periods. In other cases, there are defined “pre-performance” and “post-performance” periods. “Pre-performance” refers to a time period before a customer participated in a campaign. “Performance” refers to a time period during which the customer participated in the campaign. “Post-performance” refers to a time period after the customer's participation in the campaign was complete. FIG. 4a is a graphical representation of an example of a pre-performance period 402 and a performance period 404 used to define and validate a model. For this example, the model is a simple “spend” model that predicts how much a member of a loyalty program will spend during a future period of time. In this example, the model is built based on data of members of the loyalty program as of a selected date 406, such as, for example, July 2004. In this example, data is gathered relating to transactions that occurred between another selected date 408, such as, for example, the inception date of a loyalty program, and selected date 406. In this example, the period from inception to July 2004 is referred to herein as “pre-performance period” 402. As will be described below, the model, once built, can be used to predict spend from July 2004 to another selected date 410, such as, for example July 2005. The period from July 2004 to July 2005 is referred to herein as “performance period” 404. Since the performance period 404 has already occurred (prior to the current date 412), the model's predictions can be compared to actual data to validate the model. Further, the model data can be used to indicate the effect a marketing campaign had on a particular consumer or type of consumer.

FIG. 4b shows another example of model performance periods. In this example, a “pre-performance period” 402 is defined to be the time period from inception 414 up until current day 412. As will be described below, the model can be used to predict member behavior during a future period 416, such as the next twelve months. In this example, there is no opportunity to validate the model based on historical data. Instead, this predicted member behavior may be used to formulate business strategies accordingly.

Returning to FIG. 3, consumer data is extracted from one or more databases at step 306. This step may include sub-steps of determining a loyalty eligible population (e.g., entire consumer population, entire loyalty portfolio population, or some subset thereof), and gathering historical data. Historical data used to build models may include, for example and without limitation, loyalty program enrollment data, reward related data, customer profile, historical transactions, spend capacity, spend ability, and program value. The gathering of historical data may include gathering data from the prior campaign as well as data related to consumers who did not participate in a prior campaign. The loyalty program enrollment data may include, without limitation, program enrollment date, program enrollment cancellation date, program enrollment fee, type of reward tier enrolled and associated date, type of reward tier switched and associated date. Reward related data may include, without limitation: number of rewards points earned, number of rewards points redeemed, redemption transactions along with the associated date of the transaction, type of redemptions and cost of redemptions. Campaign related data may include, without limitation: campaign enrollment and/or response indicator, type of promotion offer, cell information, and specific campaign performance data for each individual consumer member in this specific marketing campaign. Results from a prior campaign may include, without limitation: data related to responses of multiple customers to at least one specific offer, campaign enrollment fee data, duration data, campaign enrollment date data, a response indicator, response channel data, redemption pricing data, reward points offer data, threshold data, and cap data.

For models in which performance and post-performance data exist, extracting data may also include gathering the associated performance and post-performance data.

At step 308 the defined model is developed using, for example, statistical regression analysis. Each model may include various consumer attributes and correlated effects the attributes have on consumer behavior. An example of behavior model development may be found in U.S. patent application Ser. No. 11/694,086, filed Mar. 30, 2007, which is incorporated by reference herein in its entirety. Models may be developed using an entire set or various subsets of members of the loyalty program. For example, the entire population of the loyalty program may be used to develop a set of baseline behavior models (as will be described below, baseline behavior models are behavior models not tied to a specific campaign which indicate how a customer will act if no campaign is targeted at that customer). However, for developing a campaign-specific model intended to predict customer response to a particular kind of marketing campaign, the eligible population might be a campaign-specific population of the loyalty program. For example, the model population may be consumers who have previously been targeted with the same or similar campaign.

After a particular model is developed at step 308, its performance is tested at step 310. Step 310 may include sub-steps of a) checking the accuracy of model performance (e.g., comparing how close a predicted value is versus an actual value of the dependent variable), and b) checking the discrimination power of the model (e.g., how much the volume of the actual “post spend” is captured by the top 30% of high predicted “post spenders”).

If the model developed at step 308 performs as desired at step 310, the model is tested for validity at step 312. Step 312 may include sub-steps as follows: a) applying the model results to a new post performance time period to validate whether the model works across time periods, and b) if the model performance is not satisfied, further developing the model at step 308.

If the model is valid, as tested on actual historical data, the model is coded at step 314. Model code is based on the finalized model equations, and may also be referred to herein as an algorithm. The algorithm may include, for example, weighted combinations of attributes resulting in a net profit expected from an individual consumer.

### III. Campaign Optimization for an Individual Consumer

In the past, a single marketing campaign would be used to cover a wide variety of consumers. However, it is more profitable to a company trying to increase consumer spending behavior (hereinafter, “the provider”) for the campaigns to be customized such that a campaign sent to an individual consumer is optimized for that consumer. Once the behavior models have been developed, they may be used to develop various marketing campaigns and evoke particular responses from consumers.

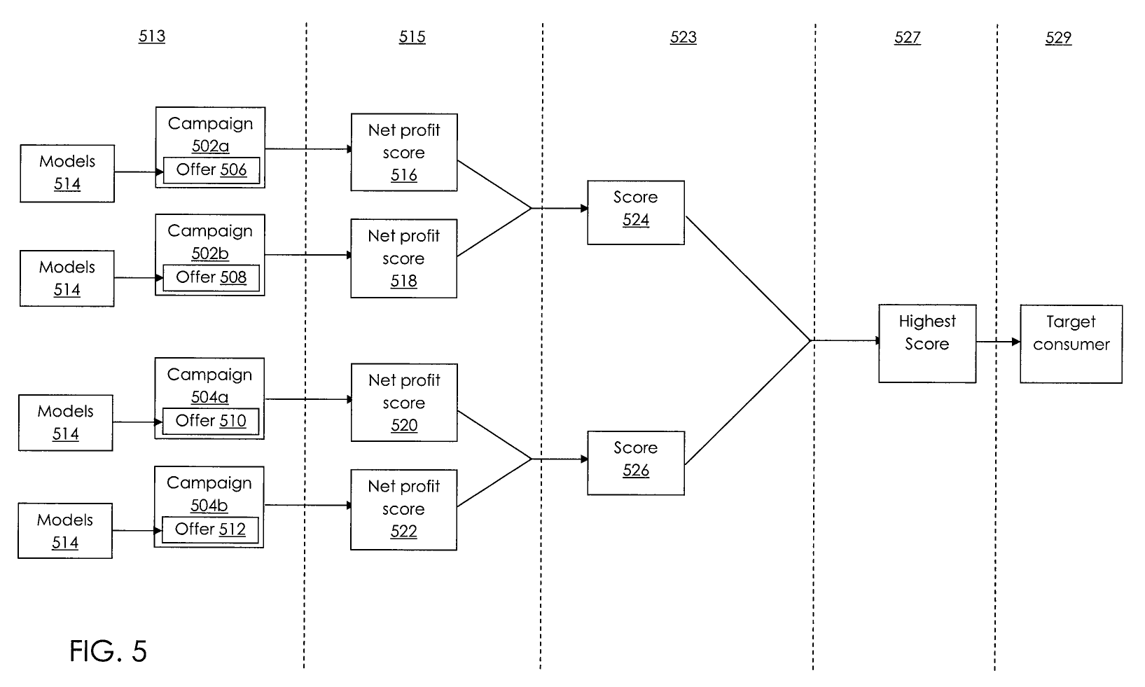

FIG. 5 is a flowchart of an example method of customizing a campaign for a particular consumer according to an embodiment of the present invention. The goal of the customization is to provide the particular consumer with a campaign resulting in the highest net profit to the loyalty program provider. As used herein, a “campaign” is a marketing campaign of a provider intended to result in a particular consumer action. For example, a “spend lift” campaign may be intended to encourage a consumer to increase the consumer's spending beyond a current level. In another example, a “redemption” campaign may be intended to encourage a consumer to redeem points in a loyalty program for items that are less costly to the provider.

As used herein, an “offer” is a feature of a campaign which can be changed depending on a customer's predicted response to that feature. An offer may also be referred to as a variable.

Offers may include, for example and without limitation, a campaign fee offer, a duration offer, a response channel offer, a threshold offer, and a cap offer. A campaign fee offer refers to the charge to the consumer for accepting the campaign (e.g., a 4.5% APR on all purchases). A duration offer refers to the length of the campaign (e.g., 3 months, 6 months, etc.). A response channel offer refers to the manner in which the consumer should respond to accept the offer (e.g., email, telephone, etc.). A threshold offer refers to a spend amount involved with the offer (e.g., a minimum amount of spend needed to participate in the campaign). A cap offer refers to a spend level over which the campaign is no longer applicable.

In the example of FIG. 5, a first campaign 502 is, for example, a spend stimulation campaign (e.g., a campaign to encourage customer spending). A second campaign 504 is, for example, a redemption campaign. Although FIG. 5 will be described with respect to only two types of campaigns, one of skill in the art will recognize that more than two types of campaigns may be compared without departing from the spirit and scope of the present invention.

For a given consumer, a set of loyalty behavior models are developed based on, for example, historical data about the consumer. A set, as used herein, may include one or more models. Each campaign 502 and 504 includes various combinations of offers that may be used in that campaign. For example, for campaign 502, a first combination of offers 506 may include the following offers: a fee of $10, a duration of 3 months, and a cap of $3,000. A second combination of offers 508 may include the following offers: a fee of $0, a duration of 6 months, and a cap of $1,500. Campaign 502 having combination of offers 506 is referred to herein as campaign 502a; campaign 502 having combination of offers 508 is referred to herein as campaign 502b.

For campaign 504, a first combination of offers 510 may include the following offers: an incentive of double points and a fee of $20. A second combination of offers 512 may include the following offers: an incentive of increased point value and a fee of $10. Campaign 504 having combination of offers 510 is referred to herein as campaign 504a; campaign 504 having combination of offers 512 is referred to herein as campaign 504b.

In step 513, each combination of offers is processed by the set of loyalty behavior models 514. In step 515, for each combination of offers, a net profit score is output. A net profit score correlates to a value of a net profit estimated to be received by a provider from the given consumer. The net profit score may be approximately equal to the net profit value, or the net profit score may be some function of the net profit value. In the example of FIG. 5, combination of offers 506 in campaign 502a outputs net profit score 516. Combination of offers 508 in campaign 502b outputs net profit score 518. For purposes of this example, net profit score 518 is higher than net profit score 516. Combination of offers 510 in campaign 504a outputs net profit score 520. Combination of offers 512 in campaign 504b outputs net profit score 522. For purposes of this example, net profit score 520 is higher than net profit score 522.

In step 523, for each campaign, the combination of offers having the highest net profit score is selected. In the example of FIG. 5, combination of offers 508 has the highest net profit score for campaign 502, which is selected as the net profit score 524 for campaign 502. Combination of offers 510 has the highest net profit score for campaign 504, which is selected as the net profit score 526 for campaign 504.

Once a highest net profit score has been determined for each campaign, the campaign having the highest net profit score is selected in step 527. For purposes of this example, net profit score 524 for campaign 502 is lower than net profit score 526 for campaign 504. Campaign 504 is thus selected as the campaign to be used for targeting the given consumer. In step 529, the individual consumer is targeted with the combination of offers in the selected campaign that is expected to provide the highest net profit to the provider. In FIG. 5, for example, the individual consumer is targeted with marketing materials for campaign 504 and combination of offers 510.

### IV. Consumer Selection to Optimize a Specific Campaign

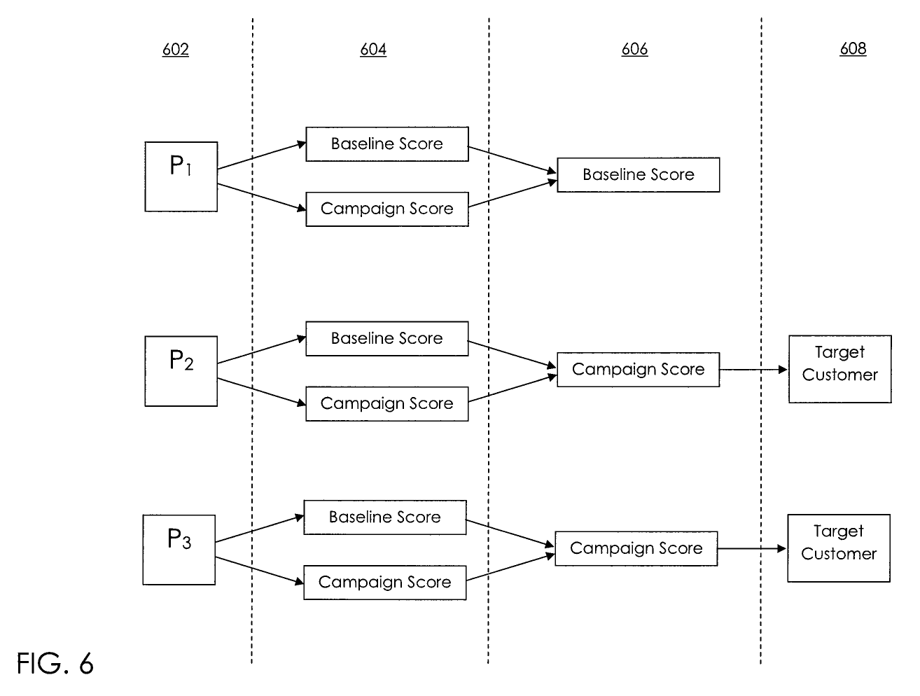

FIG. 6 is a flowchart of another targeting method according to an embodiment of the present invention. For a given campaign having a particular combination of offers, a set of campaign-specific behavior models are developed. Campaign-specific behavior models are highly driven by campaign offers and campaign performance, and can be developed as described above. A set of baseline models are also developed. A baseline model provides an indication of an individual consumer's action when no campaign is targeted at the consumer. Comparison of predicted behavior in response to a campaign to a baseline behavior provides an indication of whether the campaign will produce any real benefit (e.g., additional profit, goodwill, etc.) to the provider from the consumer, and a baseline net profit score may be a measure of the expected profitability of the consumer if the consumer does not participate in the given campaign. A baseline behavior model may be developed, for example, using data related to customers who did not participate in a prior campaign. In step 602, a plurality of customers are selected for analysis. Although FIG. 6 only illustrates three customers P₁, P₂, and P₃, one of skill in the art will recognize that any number of customers may be analyzed without departing from the spirit and scope of the present invention.

In step 604, each customer in the plurality of customers is provided with both a baseline net profit score and a campaign net profit score. The baseline net profit score may be determined by inserting at least one attribute corresponding to the customer into the set of baseline behavior models. The campaign net profit score may be determined by inserting at least one combination of offers corresponding to the customer into the set of campaign behavior models.

In step 606, it is determined for each customer which of the baseline net profit score and the campaign net profit score has a higher value for that customer. For purposes of this example, in FIG. 6, customer P₁ has a baseline score that is higher than customer P₁'s campaign score, while both customers P₂ and P₃ have campaign scores that are higher than their respective baseline scores.

In step 608, one or more of the customers whose campaign scores are higher than their baseline scores are selected for targeting. In the example of FIG. 6, both of customers P₂ and P₃ are selected for targeting. The selected customers are targeted with campaigns having the particular combination of offers analyzed.

To reduce the cost to the provider, only the most profitable customers may be targeted with the campaign. For example, if a particular provider budget is allocated to the campaign such that the campaign can only target 30% of consumers, the campaign may rank the consumers selected in step 608, and target the top 30% of the ranked consumers.

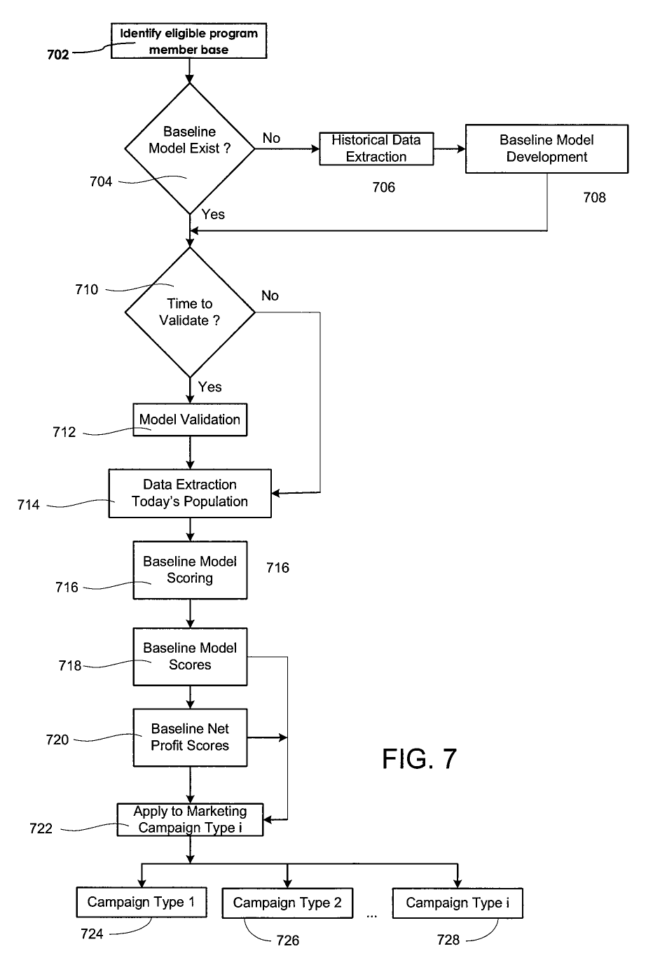

FIG. 7 is a flowchart of an exemplary process for using baseline models (not specific to a particular type of campaign) to predict a net profit score to apply and leverage into a new marketing campaign that has not previously been sent out to consumers. The process begins at 702 by identifying an eligible loyalty program member base. At 704 it is determined whether or not there already exists a baseline model of the type needed. If so, control shifts to 710. If not, a baseline model must be developed. To develop a baseline model, historical data is extracted at 706 and a baseline model is developed at 708. This step may include developing a set of loyalty behavior models. The baseline model includes loyalty program related data. Periodically all models are validated. At 710 it is determined whether the baseline model to be used is old enough to be validated. If so, the model is validated at 712. If the model is not old, model validation at 712 is skipped and control passes directly to 714 where data is extracted for a current population. Once a baseline model is built and determined to be valid, each individual consumer in the current population is scored at 716 using the baseline model. Model scores for each individual consumer are obtained at 718. Net profit scores for each individual consumer are obtained at 720 by combining the baseline model scores with other financial inputs. Inputs may include behavior model scores, financial inputs, e.g., discount rate, interest rate, card fee, loyalty program fee, etc., along with other business judgments, e.g. seasonality, etc. Once net profit scores are obtained at 720, the scores are applied to new marketing campaign types at 722 to determine appropriate campaigns, such as campaign 1 724, campaign 2 726 . . . campaign I 728, to be used for each customer. For example, if a particular new marketing campaign is desired to be used, then net profit scores obtained at 720 may be ranked to determine the customers having the highest net profit scores for the particular campaign.

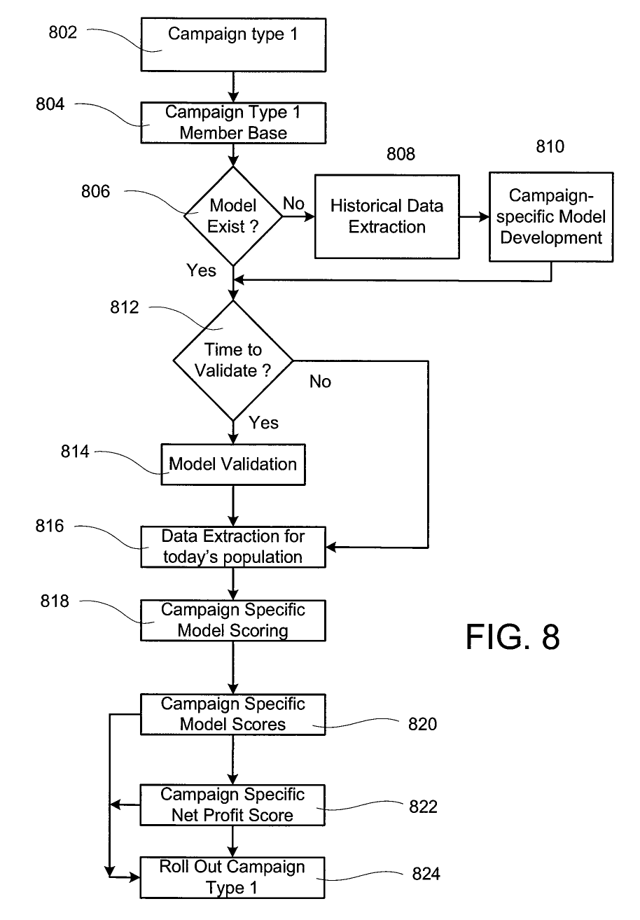

FIG. 8 is a flowchart of an exemplary process for using campaign specific models. The process begins at 802 by identifying a particular type of campaign. In this example, the particular campaign in called “Campaign Type 1”. At 804 the member base specific to Campaign Type 1 is identified. This member base includes those members who have been subjected to a campaign of Type 1 at some time in the past. At 806 it is determined whether or not there already exists a Campaign Type 1 model. If so, control shifts to 812. If not, a Campaign Type 1 model must be developed. To develop a Campaign Type 1 model, historical data is extracted at 808 and a Campaign Type 1 model is developed at 810. The historical data may include loyalty program related data and Campaign Type I specific data, including offer, channel, messaging, etc. A set of campaign-specific loyalty behavior models can be developed at 810. At 812 it is determined whether the Campaign Type 1 model is old enough to be validated. If so, the model is validated at 814. If the model is not old, model validation at 814 is skipped and control passes directly to 816 where data is extracted for a current population. Once a Campaign Type 1 model has been built and determined to be valid, each individual in the current population is scored by inserting at least one combination of offers at 818 using the Campaign Type 1 model. Campaign Type 1 model scores are obtained at 820. Net profit scores are obtained at 822 by combining the Campaign Type 1 model scores with other financial inputs. Inputs may include campaign specific behavior model scores, financial inputs, e.g., discount rate, interest rate, card fee, loyalty program fee, etc. along with other business judgments, e.g. seasonality, etc. Once net profit scores are obtained at 822, a Campaign Type 1 can be rolled out at 824 by selecting the highest campaign specific net profit score for each individual customer.

### V. Example Implementations

The present invention or any part(s) or function(s) thereof may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

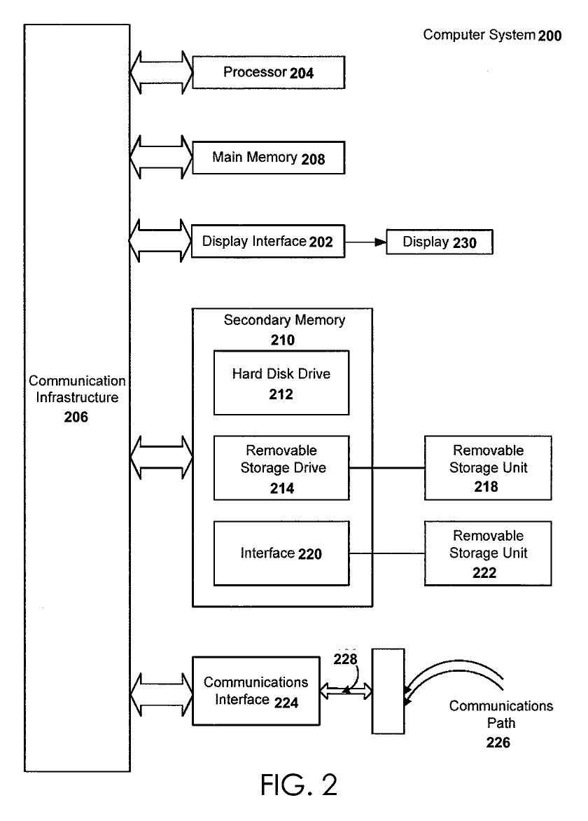

In fact, in one embodiment, the invention is directed toward one or more computer systems capable of carrying out the functionality described herein. An example of a computer system 200 is shown in FIG. 2.

The computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230.

Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc. which is read by and written to by removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228 which may be electronic, electromagnetic, optical or other signals capable of being received by communications interface 224. These signals 228 are provided to communications interface 224 via a communications path (e.g., channel) 226. This channel 226 carries signals 228 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 214 and a hard disk installed in hard disk drive 212. These computer program products provide software to computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212 or communications interface 224. The control logic (software), when executed by the processor 204, causes the processor 204 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### VI. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A method for managing a customer loyalty program for an individual member of the customer loyalty program, comprising:
gathering historical data related to multiple members of the customer loyalty program;
developing a set of loyalty behavior models for the individual member based on the historical data;
for each campaign in a plurality of campaigns, inserting at least one combination of offers into each loyalty behavior model to output a plurality of net profit scores for the individual member, wherein each combination of offers outputs a separate net profit score;
for each campaign in the plurality of campaigns, selecting the combination of offers having the highest net profit score for the campaign, wherein the net profit score for the selected combination of offers becomes the campaign's net profit score;
selecting the campaign having the highest net profit score of the plurality of campaigns; and
transmitting marketing materials for the selected campaign and combination of offers to the individual member.

2. The method of claim 1, wherein the historical data includes data received as a result of at least one prior campaign.

3. The method of claim 2, wherein the data received as a result of at least one prior campaign includes data related to responses of multiple consumers to at least one specific offer.

4. The method of claim 2, wherein the data received as a result of at least one prior campaign includes at least one of campaign enrollment fee data, duration data, campaign enrollment date data, a response indicator, response channel data, threshold data, and cap data.

5. The method of claim 1, wherein the historical data related to multiple members of the customer loyalty program includes at least one of loyalty program enrollment data, reward-related data, customer profile data, historical transaction data, spend capacity data, spend ability data, and program value proposition data.

6. The method of claim 1, wherein an offer in the combination of offers is at least one of a campaign fee offer, a duration offer, a channel to respond offer, a threshold offer, and a cap offer.

7. A method for targeting a customer loyalty program member for a marketing campaign, comprising:
gathering historical data related to multiple customer loyalty program members;
developing a set of loyalty behavior models for a given campaign based on the historical data;
developing a set of baseline behavior models based on the historical data;
for each individual of a plurality of individuals, inserting at least one combination of offers of the individual into each loyalty behavior model for the given campaign, wherein a separate campaign net profit score is output for each individual;
for each individual of the plurality of individuals, inserting at least one attribute of the individual into the baseline behavior model, wherein a separate baseline net profit score is output for each individual;
comparing a highest campaign net profit score for each individual to the baseline net profit score for the individual;
from the plurality of individuals, selecting at least one individual having a campaign net profit score that is higher than the baseline net profit score for the individual; and
transmitting marketing materials for the given campaign to the selected at least one individual.

8. The method of claim 7, wherein the historical data includes data received as a result of at least one prior campaign.

9. The method of claim 8, wherein the historical data further includes data related to customer loyalty program members who did not participate in the at least one prior campaign.

10. The method of claim 9, wherein developing the baseline behavior model comprises developing the baseline behavior model based on the data related to customer loyalty program members who did not participate in the at least one prior campaign.

11. The method of claim 7, wherein the baseline net profit score is a measure of the expected profitability of the individual if the individual does not participate in the given campaign.

12. The method of claim 7, wherein the at least one attribute is one of the group consisting of: loyalty program enrollment status, historical transaction, spend ability, program value proposition, age, gender, location, spend capacity, income, and spend ability.

13. A method for targeting a customer loyalty program member for a new type of marketing campaign, comprising:
gathering historical data related to multiple customer loyalty program members;
developing a set of baseline behavior models based on the historical data;
for each individual of a plurality of individuals, inserting at least one attribute of the individual into the set of baseline behavior models, wherein a separate baseline net profit score is output for each individual;
ranking each individual based on the baseline net profit score output for the individual;
from the plurality of individuals, selecting at least one individual based on the ranked baseline net profit scores; and
transmitting marketing materials for the new type of campaign to the selected at least one individual.

14. A system for managing a customer loyalty program for an individual member of the customer loyalty program, comprising:
a database configured to store historical data related to multiple members of the customer loyalty program;
a modeling system configured to develop a set of loyalty behavior models for the individual member based on the historical data in the database;
a processing system configured to evaluate, for each campaign in a plurality of campaigns, each loyalty behavior model using at least one permutation of offers and output a plurality of net profit scores for the individual member, wherein the processing system outputs a separate net profit score for each permutation of offers;
a first comparator system configured to compare the net profit scores output by the processing system and identify and output, for each campaign in the plurality of campaigns, the permutation of offers having the highest net profit score for the campaign and assign the net profit score for the selected combination of offers as the campaign's net profit score;
a second comparator system configured to compare the assigned net profit scores of the plurality of campaigns and identify and output the campaign having the highest net profit score of the plurality of campaigns; and
a marketing system configured to transmit to the individual member marketing materials corresponding to the campaign and permutation of offers output by the second comparator system.

15. The system of claim 14, wherein the processing system is configured to
evaluate each loyalty behavior model using at least one permutation of offers to output a plurality of net profit scores for the individual member, wherein each permutation of offers results in a separate model net profit score, and wherein the processing system is further configured to output a combination of the plurality of model net profit scores as a campaign net profit score.

16. The system of claim 14, wherein the database is configured to store data received as a result of at least one prior campaign.

17. The system of claim 16, wherein the data received as a result of at least one prior campaign includes data related to responses of multiple consumers to at least one specific offer.

18. The system of claim 16, wherein the data received as a result of at least one prior campaign includes at least one of campaign enrollment fee data, duration data, campaign enrollment date data, a response indicator, response channel data, redemption pricing data, reward points offer data, threshold data, and cap data.

19. The system of claim 14, wherein an offer in the permutation of offers is at least one of a campaign fee offer, a duration offer, a channel to respond offer, a redemption pricing offer, a reward points offer, a threshold offer, and a cap offer.

20. A system for targeting a customer loyalty program member for a marketing campaign, comprising:
a database configured to store historical data related to multiple customer loyalty program members;
a first modeling system configured to develop a set of loyalty behavior models for a given campaign based on historical data in the database;
a second modeling system configured to develop a set of baseline behavior models based on historical data in the database;
a first processing system configured to evaluate, for each individual in a plurality of individuals, each loyalty behavior model using at least one combination of offers of the individual and output a campaign net profit score for each individual;
a second processing system configured to process, for each individual in the plurality of individuals, the baseline behavior model using at least one attribute of the individual and output a baseline net profit score for each individual;
a comparator system configured to compare the campaign net profit score for each individual with the baseline net profit score for the individual and identify and output at least one individual having a campaign net profit score higher than the corresponding baseline net profit score; and
a marketing system configured to transmit marketing materials for the given campaign to the at least one individual output by the comparator.

21. The system of claim 20, wherein the historical database is configured to store data received as a result of at least one prior campaign.

22. The system of claim 21, wherein the historical database is further configured to store data related to customer loyalty program members who did not participate in the at least one prior campaign, and wherein the second modeling system configured to develop a baseline behavior model utilizes the data related to customer loyalty program members who did not participate in the at least one prior campaign.

23. The system of claim 22, wherein the baseline net profit score is a measure of the expected profitability of the individual if the individual does not participate in the given campaign.

24. The system of claim 22, wherein the at least one attribute is one of the group consisting of: customer profile, spend capacity, spend ability, and program value proposition.

25. A system for targeting a customer loyalty program member for a marketing campaign, comprising:
a database configured to store historical data related to multiple customer loyalty program members;
a modeling system configured to develop a set of baseline behavior models based on historical data in the database;
a processing system configured to process, for each individual in the plurality of individuals, the baseline behavior model using at least one attribute of the individual and output a baseline net profit score for each individual; and
a ranking system configured to rank the baseline net profit score.
